(19) United States
(12) Patent Application Publication
(10) Pub. No.: US 2026/0260123 A1
(43) Pub. Date: Sep. 3, 2026

(54) MULTI-USER COOPERATION PLATFORM BASED ON EDGE COMPUTATION AND DIRECTED ACYCLIC GRAPH AND METHOD THEREOF

(71) Applicant: TIANJIN UNIVERSITY, Tianjin (CN)

(72) Inventors: Xiaobo ZHOU, Tianjin (CN); Tie QIU, Tianjin (CN); Tianyi XU, Tianjin (CN); Weixu WANG, Tianjin (CN); Pengbo LIU, Tianjin (CN); Shuxin GE, Tianjin (CN); Qi XIE, Tianjin (CN)

(21) Appl. No.: 19/138,106

(22) PCT Filed: Aug. 16, 2023
(86) PCT No.: PCT/CN2023/113254

§ 371 Date: Jun. 12, 2025

(30) Foreign Application Priority Data
Aug. 6, 2022 (CN) 202210983474.7

(51) Int. Cl. G06N 3/092; G06N 3/045; G06N 7/01

(52) U.S. Cl. CPC G06N 3/092; G06N 3/045; G06N 7/01

(57) ABSTRACT

Disclosed is a multi-user cooperation platform based on edge computation and a directed acyclic graph, a cooperation method is based on an edge computation platform, the edge computation platform comprises a base station, an external state acquisition module, a deep reinforcement learning decision module and a coordination system, and an external environment information acquisition module is configured for acquiring a channel gain between a current base station and each user, so that the coordination system obtains a current Internet condition; the deep reinforcement learning decision module is configured for outputting a multi-user cooperation strategy, an offloading strategy and a local computation frequency strategy; and the deep reinforcement learning decision module comprises a multivariate neural network unit, an intelligent agent, a convergence training unit and an experience pool.

This application claims priority to Chinese Patent Application No. 202210983474.7, entitled “MULTI-USER COOPERATION PLATFORM BASED ON EDGE COMPUTATION AND DIRECTED ACYCLIC GRAPH AND METHOD,” filed on Aug. 16, 2022 in China Intellectual Property Administration (CNIPA), which is hereby incorporated in this application for reference.

### TECHNICAL FIELD

The present invention relates to the field of multi-access edge computation and multi-user cooperation in the Internet, and particularly to a multi-user cooperation platform based on edge computation and a directed acyclic graph and a method thereof.

### BACKGROUND OF THE PRESENT INVENTION

At present, there is often the problem of poor application performance when a single user completes a task alone. For example, in the field of unmanned driving, existing single vehicle sensing is often difficult to ensure the safety of vehicle because of obstacle blockage, accuracy limitation of sensing algorithm itself, and other problems.

In addition, in the field of unmanned aerial vehicle tracking, there is also the problem that single vehicle tracking is easy to lose a target. In view of the above problem, an idea of multi-user cooperation is utilized in more and more scenarios involving multiple mobile devices which run the same application program, that is, users may cooperatively process the application program by sharing intermediate results of a subtask, so as to improve the performance of the application program. This is because the same program often has consistent data requirements, and the sharing of intermediate results of program operation can improve their application performance. For example, in collaborative sensing of interconnected autonomous vehicles, different vehicles share their sensing information, such as feature data extracted from detection results of cameras, so as to improve the sensing ability to a target detection accuracy and a sensing range. As shown in FIG. 1, the step of generating a sensing result depends on feature extraction data, after a vehicle 2 receives feature data of a vehicle 1 and a vehicle 3, a sensing range of the vehicle 2 can be enlarged, so as to improve a sensing accuracy, which is of great benefit to automatic driving under complex road conditions.

The above-mentioned applications, such as target sensing, require a large computation quantity and a high real-time performance, which are typical computation-intensive and delay-sensitive applications. When executing such applications, the mobile devices generally face the problems that the computation quantity is too large to ensure the real-time performance and the low energy reserve is difficult to meet high energy consumption. Facing these problems, multi-access edge computation has become an effective method. The core of the multi-access edge computation to solve the above problems lies in computation offloading. By deploying a relatively resource-rich edge computation platform in a base station near a mobile user, the user may transfer a computation task to a nearby base station through a wireless channel, and receive results sent back from the base station after the task is executed. Compared with traditional cloud computation, a high-power server is placed far away from the user. Multi-access edge computation reduces communication expenses of the network by providing short-range services, greatly reduces execution delay and energy consumption of applications, and provides a guarantee for efficiently executing delay-sensitive and computation-intensive applications on the mobile devices with limited computation ability and energy reserve.

Under normal conditions, the computation-intensive application consists of a series of interdependent subtasks, wherein a dependent relationship between the subtasks may be modeled through a directed acyclic graph. According to the directed acyclic graph, the subtasks should be executed in a specified order, that is, a subtask may be started when intermediate results of a previous subtask are received. These applications modeled as directed acyclic graphs may be combined with the computation offloading of multi-access edge computation, which may make a grain size of offloading finer, thereby further promoting the performance improvement of edge offloading on the applications. At present, there have been a large number of task offloading strategies of directed acyclic graphs. By considering the execution order of the subtasks into the offloading strategies, we can make an offloading decision for each subtask, so that a mobile application program is executed completely in parallel between an edge server and a mobile device, thereby minimizing the execution delay of the application program and the energy consumption of the mobile device, and improving the overall performance of the application program.

At present, most of the research works on an edge offloading mechanism based on the directed acyclic graph do not consider multi-user cooperation, that is, the application of each user is executed separately. As a decision-making subject, each user makes an independent offloading strategy for a subtask of the user according to an external environment (network situation and computation resources of various computation nodes) of the user. Because each user only considers himself or herself without considering decisions of other users, it is often difficult to achieve the best performance in multi-user scenarios. Moreover, this scheme does not take into account the problem of multi-user cooperation to provide a cooperation gain for a system, so that the system is difficult to achieve the best performance of the application program.

In other works considering multi-user cooperation based on the directed acyclic graph, a cooperative relationship between users is assumed to be fixed. There is a fixed dependent relationship between subtasks of multiple users, that is, the users merge data of fixed types and fixed sizes through a fixed mode regardless of dynamic changes of computation resources and network conditions, which is extremely easy to cause huge time delay when a network state fluctuates, ignoring a dynamic influence of dynamic property of external environment on the cooperation effect. Meanwhile, the above existing work also ignores the adjustability of local computation frequency, which is very beneficial for optimizing energy consumption of task execution.

From the above analysis, we can know that, on one hand, a transmission rate in the process of offloading the mobile device to the edge server is affected by a current network state, and the transmission rate will directly affect the time delay and energy consumption of transmission, so that it is very important to design an offloading scheme that can minimize the time delay and energy consumption. On the other hand, because of the influences of network bandwidth, computation resources and other factors, we need to dynamically consider whether the multi-user cooperation is carried out and how much data will be transmitted between the multiple users, rather than deciding whether to cooperate or not changelessly. Therefore, our directed acyclic graphs are changing dynamically, that is to say, whether the multiple users will cooperate with each other may affect an offloading decision and a local computation frequency decision, and the three are coupled with each other, which causes extremely high computation complexity. Once an approximate optimal solution cannot be found quickly, the application performance will be greatly affected.

### SUMMARY OF THE PRESENT INVENTION

The present invention provides a multi-user cooperation platform based on edge computation and a directed acyclic graph, which adapts to a dynamic network change, and an application method thereof. According to the present invention, a deep reinforcement learning technology is used to solve an offloading strategy, a user cooperation strategy and a local cpu frequency strategy of each subtask in a computation-intensive application, and a comprehensive performance of each application in a system is improved from three aspects of time delay, energy consumption and cooperation gain.

In order to solve the problem of the prior art, the following technical solution is used in the present invention.

A multi-user cooperation platform based on edge computation and a directed acyclic graph is provided, wherein a cooperation method is based on an edge computation platform the edge computation platform comprises a base station, an external state acquisition module, a deep reinforcement learning decision module and a coordination system, wherein:
an external environment information acquisition module is configured for acquiring a channel gain between a current base station and each user, so that the coordination system obtains a current Internet condition;
the deep reinforcement learning decision module is configured for outputting a multi-user cooperation strategy, an offloading strategy and a local computation frequency strategy; and the deep reinforcement learning decision module comprises a multivariate neural network unit, an intelligent agent, a convergence training unit and an experience pool;
the multivariate neural network unit solves a single-user offloading decision, a multi-user cooperation decision and a local computation frequency decision by a BSAC algorithm to obtain a final decision; that is:

$$reward ( t ) = α G ( t ) - β {\sum }_{n = 1}^{N} {d}_{n , M} ( t ) - γ {\sum }_{n = 1}^{N} {e}_{n} ( t )$$

wherein: α is a weight of cooperation gain; G(t) is a cooperation gain of time slot t; d_{n,M}(t) is completion time of application of a user n in the time slot t; β is a weight of time delay; eₙ(t) is energy consumption of the user n in the time slot t; and γ is a weight of energy consumption;
the intelligent agent generates a sharing strategy by parallel calculation according to a network state space provided by the external environment information acquisition module and the final decision provided by the multivariate neural network unit;
the experience pool reserves historical decision information of storage state between the current base station and each user provided by the external environment information acquisition module; and
the convergence training unit continuously updates the intelligent agent according to the historical decision information provided by experience pool the and an application use performance.

In order to solve the problem of the prior art, the following technical solution is further used in the present invention.

Cooperation carried out by the multi-user cooperation platform based on the edge computation and the directed acyclic graph comprises the following steps:
obtaining, by the external environment information acquisition module, the channel gain

$${h}_{n}^{t}$$

between each user and the base station through the following formula:

$${h}_{n}^{t} = {{A}_{d} ( \frac{3 * 1 {0}^{8}}{4 π {f}_{c} {L}_{n}^{t}} )}^{PL}$$

wherein: A_{d} is the antenna gain, f_{c} is the carrier frequency, and PL is the path loss;

$${L}_{n}^{t}$$

represents the Euclidean distance between the user and the base station; the

$${L}_{n}^{t}$$

is a distance

$${L}_{n}^{t} = {( {( {u}_{n}^{t} \cdot x - {u}_{n}^{t} \cdot x )}^{2} - {( {u}_{n}^{t} \cdot y - {u}_{n}^{t} \cdot y )}^{2} )}^{0.5}$$

between the user n and the base station calculated according to coordinates

$$( {u}_{0}^{t} \cdot x , {u}_{0}^{t} \cdot y )$$

of the base station and coordinates

$$( {u}_{n}^{t} \cdot x , {u}_{n}^{t} \cdot y )$$

of the user n; and
outputting, by the deep reinforcement learning decision module, the multi-user cooperation strategy, the offloading strategy and the local computation frequency strategy, which comprises the following process:
step 2.1: constructing a multivariate neural network by the BSAC algorithm through a reinforcement learning network and outputting the following final decision:

$$reward ( t ) = α G ( t ) - β {\sum }_{n = 1}^{N} {d}_{n , M} ( t ) - γ {\sum }_{n = 1}^{N} {e}_{n} ( t )$$

wherein: α is the weight of cooperation gain; G(t) is the cooperation gain of time slot t; d_{n,M}(t) is the completion time of application of the user n in the time slot t; β is the weight of time delay; eₙ(t) is the energy consumption of the user n in the time slot t; and γ is the weight of energy consumption;
step 2.2: updating, by the external environment information acquisition module, the intelligent agent according to the following state space S;

$$S = [ {h}_{1}^{t} , {h}_{2}^{t} , ... , {h}_{n}^{t} ]$$

wherein:

$${h}_{n}^{t}$$

is a channel gain of the user n in the time slot t;
step 2.3: obtaining, by the intelligent agent, corresponding information according to the state space and calculating, by a plurality of neural networks, the information simultaneously, and integrating results of the plurality of neural networks and outputting a current action a to the external environment information acquisition module;
step 2.4: generating, by the external environment information acquisition module, a series of information while making decisions continuously and storing the information in a form of combination T=[s′, a, r, s], inputting the combinations into the experience pool first, and extracting each combination from the experience pool when training the multivariate neural network; wherein the network is trained at intervals according to the information during network training and an intelligent agent network is updated; wherein:
s′ is state space information of a previous moment; a is a current selecting action; and r is a reward value of a previous selecting action; and
step 2.5: updating, by the external environment information acquisition module, a system target of the coordination system through the following formula, that is:

$$\begin{matrix}max \\ X , Y , τ\end{matrix} {\sum }_{t = 1}^{T} reward ( t )$$

$$s . t . {x}_{n , m}^{t} ∈ \{ 0 , 1 \} , m ∈ \{ 2 , ... , M - 1 \} , ∀ t , n ,$$

$${x}_{n , 1}^{t} = 0 , {x}_{n , M}^{t} = 0 , ∀ t , n ,$$

$${y}_{j}^{t} ∈ [ 0 , 1 ] , ∀ t , j ,$$

$${τ}_{n}^{t} ∈ [ 0.1 , 1 ] , ∀ t , n .$$

Further, the cooperation gain G(t) of the time slot t is constructed through the following formula:

$$G ( t ) = log 10 ( {y}_{j}^{t} * {O}_{m 1 , m 2} ) ;$$

wherein, each multi-user cooperation decision of the time slot t in the system is

$${y}_{j}^{t} ,$$

j∈{1,2, . . . , J}, and when

$${y}_{j}^{t} = 1 ,$$

a transmission data volume is O_{m1, m2}.

Further, the energy consumption eₙ(t) of the user n in the time slot t is constructed through the following formula:

$${e}_{n} ( t ) = {μ}_{n} ( {τ}_{n}^{t} {f}_{n} ) {C}_{n , i} + {P}_{n} * {T}_{n}^{t}$$

wherein, energy consumption of local computation is controlled by the local computation frequency decision

$${τ}_{n}^{t} ∈ [ 0.1 , 1 ] ;$$

a computation method of the energy consumption of local computation is that energy consumption of task computation is equal to a product of a number of revolutions of cpu required by the task and energy consumption of each revolution of cpu; and the energy consumption of each revolution of cpu is

$${μ ( {T}_{n}^{t} {f}_{n}^{l} )}^{2} ,$$

time consumption of transmission from the local to the edge is

$${T}_{n}^{t} ,$$

and a transmission frequency is Pₙ. C_{n,i} is the total computation amount of tasks in time slot t.

### Beneficial Effects

(1) According to the multi-user cooperation strategy based on the directed acyclic graph in the present invention: whether different cooperative relationships between multiple users need to exist and how much data needs to be transmitted are dynamically determined, so as to realize the optimal application performance.

(2) According to the optimal offloading strategy of task graph in the edge scenario in the present invention: under a dynamic user task graph, an approximately optimal offloading scheme is obtained for each task, so as to optimize the application performance.

(3) The dynamic local calculation frequency is determined for each user in the present invention: the local computation frequency of each user is dynamically adjusted, so as to optimize the application performance.

(4) The present invention provides the method for jointly making the multi-user cooperation decision and the task offloading decision in the multi-user multi-access edge computation scenario, so as to realize the function of optimizing the application performance.

(5) The present invention proposes that the transmission data volume of multi-user cooperation may be dynamically changed, and the local computation frequency of each user may also be dynamically changed, so as to realize the function of optimizing the application performance under joint consideration of time delay, cooperation gain and energy consumption.

(6) The present invention provides the BSAC algorithm adapting to a large decision space, and an Actor part is expanded into the plurality of neural networks for parallel decision-making based on an original SAC algorithm, so as to improve the performance of the system in the large decision space.

### DESCRIPTION OF THE DRAWINGS

FIG. 1 is a schematic structural diagram of a multi-user cooperative relationship in vehicle sensing according to the present invention;

FIG. 2 is a schematic diagram of a multi-user cooperation strategy module based on edge computation and a directed acyclic graph in the present invention;

FIG. 3 is a work flow chart of an external environment information acquisition module in the present invention; and

FIG. 4 is a schematic structural diagram of a deep reinforcement learning network in the present invention.

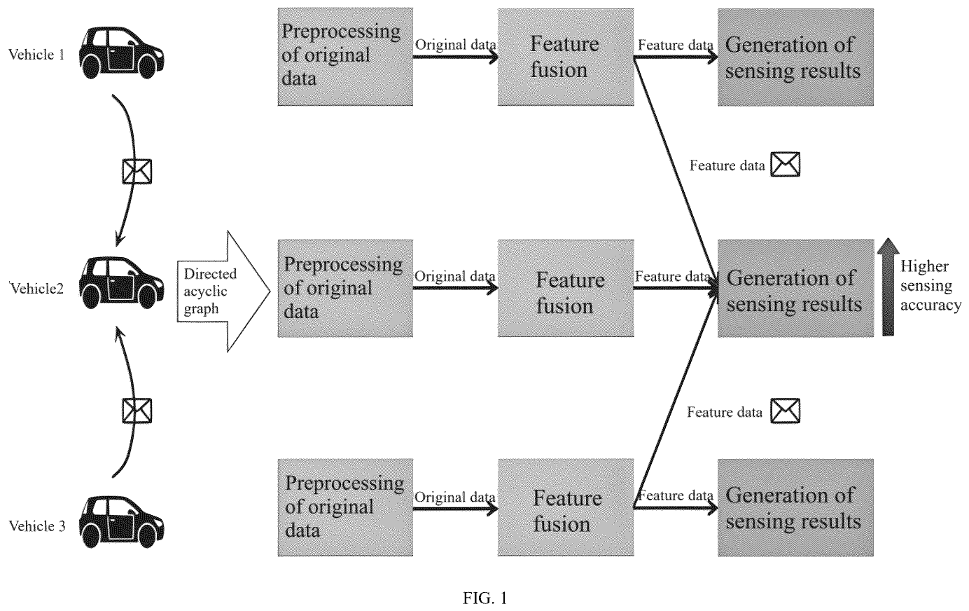

### DETAILED DESCRIPTION OF PREFERRED EMBODIMENTS

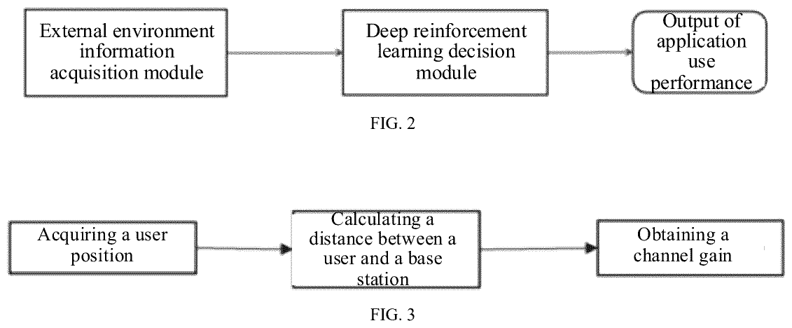

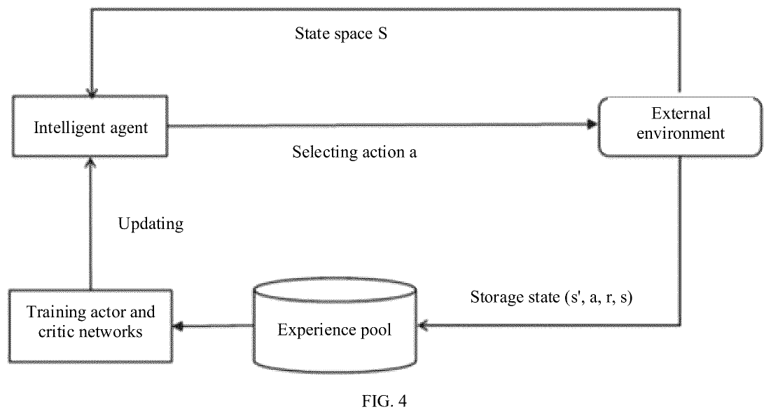

The present invention provides a multi-user cooperation platform based on edge computation and a directed acyclic graph, and an implementation process of the patent application of the present invention is further described in detail hereinafter with reference to FIG. 2 to FIG. 4.

The present invention provides a multi-user cooperation method based on edge computation and a directed acyclic graph, wherein the cooperation method is based on an edge computation platform and the edge computation platform comprises a base station, an external state acquisition module, a deep reinforcement learning decision module and a coordination system, as shown in FIG. 2, wherein:
an external environment information acquisition module is configured for acquiring a channel gain between a current base station and each user, so that the coordination system obtains a current Internet condition;
the deep reinforcement learning decision module is configured for outputting a multi-user cooperation strategy, an offloading strategy and a local computation frequency strategy; and the deep reinforcement learning decision module comprises a multivariate neural network unit, an intelligent agent, a convergence training unit and an experience pool, wherein:
the multivariate neural network unit solves a single-user offloading decision, a multi-user cooperation decision and a local computation frequency decision by a BSAC algorithm to obtain a final decision; that is:

$$reward ( t ) = α G ( t ) - β {\sum }_{n = 1}^{N} {d}_{n , M} ( t ) - γ {\sum }_{n = 1}^{N} {e}_{n} ( t )$$

wherein: α is a weight of cooperation gain; G(t) is a cooperation gain of time slot t; d_{n,M}(t) is completion time of application of a user n in the time slot t; β is a weight of time delay; eₙ(t) is energy consumption of the user n in the time slot t; and γ is a weight of energy consumption;
the intelligent agent generates a sharing strategy by parallel calculation according to a network state space provided by the external environment information acquisition module and the final decision provided by the multivariate neural network unit;
the experience pool reserves historical decision information of storage state between the current base station and each user provided by the external environment information acquisition module; and
the convergence training unit continuously updates the intelligent agent according to the historical decision information provided by experience pool the and an application use performance.

In order to solve the problem of the prior art, the following technical solution is further used in the present invention.

The multi-user cooperation method based on the edge computation and the directed acyclic graph comprises the following steps:
obtaining, by the external environment information acquisition module, the channel gain

$${h}_{n}^{t}$$

between each user and the base station through the following formula:

$${h}_{n}^{t} = {{A}_{d} ( \frac{3 * {10}^{8}}{4 π {f}_{c} {L}_{n}^{t}} )}^{PL}$$

wherein: A_{d} is an antenna gain, f_{c} is a carrier frequency, and PL is a path loss index;

$${L}_{n}^{t}$$

represents an Euclidean distance between the user and the base station; the

$${L}_{n}^{t}$$

is a distance

$${L}_{n}^{t} = {( {( {u}_{n}^{t} \cdot x - {u}_{n}^{t} \cdot x )}^{2} - {( {u}_{n}^{t} \cdot y - {u}_{n}^{t} \cdot y )}^{2} )}^{0.5}$$

between the user n and the base station calculated according to coordinates

$$( {u}_{n}^{t} \cdot x , {u}_{n}^{t} \cdot y )$$

of the base station and coordinates

$$( {u}_{n}^{t} \cdot x , {u}_{n}^{t} \cdot y )$$

of the user n; and
outputting, by the deep reinforcement learning decision module, the multi-user cooperation strategy, the offloading strategy and the local computation frequency strategy, which comprises the following process.

In step 2.1: a multivariate neural network is constructed by the BSAC algorithm through a reinforcement learning network. According to the present invention, when the neural multivariate network is constructed, an actor part is trained into a plurality of independent neural networks according to different action attributes based on the convergence training unit, results are input into a critic network for training, and finally, the intelligent agent is updated continuously. The way of obtaining the final decision by solving the single-user offloading decision, the multi-user cooperation decision and the local computation frequency decision of the intelligent agent can effectively solve the problem of difficult convergence caused by an excessively large action space in deep reinforcement learning. The final decision is as follows:

$$reward ( t ) = α G ( t ) - β {\sum }_{n = 1}^{N} {d}_{n , M} ( t ) - γ {\sum }_{n = 1}^{N} {e}_{n} ( t )$$

wherein: α is the weight of cooperation gain; G(t) is the cooperation gain of time slot t; d_{n,M}(t) is the completion time of application of the user n in the time slot t; β is the weight of time delay; eₙ(t) is the energy consumption of the user n in the time slot t; and γ is the weight of energy consumption; and meanwhile:
for the cooperation gain G(t) of time slot T: because multi-user cooperation has marginal utility, that is, the improvement of application performance will be very low when the transmission data volume is too large, we will set the cooperation gain to be log 10 of the transmission data volume. Each multi-user cooperation decision of the time slot t in the system is

$${y}_{j}^{t} ,$$

j∈{1,2, . . . , J}, and when

$${y}_{j}^{t} = 1 ,$$

a transmission data volume is O_{m1, m2}.

$$G ( t ) = log 10 ( {y}_{j}^{t} * {O}_{m 1 , m 2}$$

For the completion time d_{n,M}(t) of application of the user n in the time slot t: in a task dependency graph, the completion of the last subtask may be considered as the completion of the whole application, and completion time of the last subtask (with a serial number M) is regarded as completion delay of an application n.

The energy consumption eₙ(t) of the user n in the time slot t consists of energy consumption of local computation and energy consumption of transmission to the edge, and is obtained through the following formula:

$${e}_{n} ( t ) = {μ}_{n} ( {τ}_{n}^{t} {f}_{n}^{l} ) {C}_{n , i} + {P}_{n} * {T}_{n , i}^{s , t}$$

wherein, the energy consumption of local computation is controlled by the local computation frequency decision

$${τ}_{n}^{t} ∈ [ 0.1 , 1 ] ;$$

a computation method of the energy consumption of local computation is that energy consumption of task computation is equal to a product of a number of revolutions of cpu required by the task and energy consumption of each revolution of cpu; and the energy consumption of each revolution of cpu is

$${μ}_{n} ( {τ}_{n}^{t} {f}_{n}^{l} ) ,$$

time consumption of transmission from the local to the edge is

$${T}_{n}^{t} ,$$

and a transmission frequency is Pₙ. C_{n,i} is the total computation amount of tasks in time slot t.

In step 2.2, the intelligent agent is updated by the external environment information acquisition module according to the following state space S;

$$S = [ {h}_{1}^{t} , {h}_{2}^{t} , … , {h}_{n}^{t} ]$$

wherein,

$${h}_{n}^{t}$$

is a channel gain of the user n in the time slot t.

In step 2.3: the intelligent agent obtains corresponding information according to the state space and a plurality of neural networks calculate the information simultaneously, and results of the plurality of neural networks are integrated and a current action a is output to the external environment information acquisition module.

In step 2.4, a series of information is generated by the external environment information acquisition module while making decisions continuously and stored in a form of combination T=[s′,a,r,s], the combinations are input into the experience pool first, and each combination is extracted from the experience pool when training the multivariate neural network. The network is trained at intervals according to the information during network training and an intelligent agent network is updated; wherein:

s′ is state space information of a previous moment; a is a current selecting action; and r is a reward value of a previous selecting action.

In step 2.5, a system target of the coordination system is updated by the external environment information acquisition module through the following formula, that is:

$$\begin{matrix}max \\ X , Y , τ\end{matrix} {\sum }_{t = 1}^{T} reward ( t )$$

$$s . t . {x}_{n , m}^{t} ∈ \{ 0 , 1 \} , m ∈ \{ 2 , ... , M - 1 \} , ∀ t , n ,$$

$${x}_{n , 1}^{t} = 0 , {x}_{n , M}^{t} = 0 , ∀ t , n ,$$

$${y}_{j}^{t} ∈ [ 0 , 1 ] , ∀ t , j ,$$

$${τ}_{n}^{t} ∈ [ 0.1 , 1 ] , ∀ t , n .$$

The present invention is not limited to the embodiments described above. The above description of specific embodiments is intended to describe and illustrate the technical solution of the present invention, and the above specific embodiments are only illustrative and not restrictive. Without departing from the purpose of the present invention and the scope of protection of the claims, those of ordinary skills in the art may also make many specific changes under the inspiration of the present invention, which are all included in the scope of protection of the present invention.

1. (canceled)

2. A cooperation method based on edge computation and a directed acyclic graph using a multi-user platform, wherein a cooperation method is based on an edge computation platform, and the edge computation platform comprises a base station, an external state acquisition module, a deep reinforcement learning decision module and a coordination system, wherein:
an external environment information acquisition module is configured for acquiring a channel gain between a current base station and each user, so that the coordination system obtains a current Internet condition;
the deep reinforcement learning decision module is configured for outputting a multi-user cooperation strategy, an offloading strategy and a local computation frequency strategy; and the deep reinforcement learning decision module comprises a multivariate neural network unit, an intelligent agent, a convergence training unit and an experience pool;
the multivariate neural network unit solves a single-user offloading decision, a multi-user cooperation decision and a local computation frequency decision by a BSAC algorithm to obtain a final decision; that is:
wherein: α is a weight of cooperation gain; G(t) is a cooperation gain of time slot t; d_{n,M}(t) is completion time of application of a user n in the time slot t; β is a weight of time delay: eₙ(t) is energy consumption of the user n in the time slot t; and γ is a weight of energy consumption;
the intelligent agent generates a sharing strategy by parallel calculation according to a network state space provided by the external environment information acquisition module and the final decision provided by the multivariate neural network unit;
the experience pool reserves historical decision information of storage state between the current base station and each user provided by the external environment information acquisition module; and
the convergence training unit continuously updates the intelligent agent according to the historical decision information provided by experience pool the and an application use performance;
the cooperation method comprises the following steps:
obtaining, by the external environment information acquisition module, the channel gain
$${h}_{n}^{t}$$
between each user and the base station through the following formula:
$${h}_{n}^{t} = {{A}_{d} ( \frac{3 * {10}^{8}}{4 π {f}_{c} {L}_{n}^{t}} )}^{PL}$$
wherein: A_{d} is an antenna gain, f_{c} is a carrier frequency, and PL is a path loss index;
$${L}_{n}^{t}$$
represents an Euclidean distance between the user and the base station; the
$${L}_{n}^{t}$$
is a distance between the user n and the base station calculated according to coordinates of the base station and coordinates of the user n; and
outputting, by the deep reinforcement learning decision module, the multi-user cooperation strategy, the offloading strategy and the local computation frequency strategy, which comprises the following process:
step 2.1: constructing a multivariate neural network by the BSAC algorithm through a reinforcement learning network and outputting the following final decision:
$$reward ( t ) = α G ( t ) - β {\sum }_{n = 1}^{N} {d}_{n , M} ( t ) - γ {\sum }_{n = 1}^{N} {e}_{n} ( t ) ;$$
wherein: α is the weight of cooperation gain; G(t) is the cooperation gain of time slot t; d_{n,M}(t) is the completion time of application of the user n in the time slot t; β is the weight of time delay; eₙ(t) is the energy consumption of the user n in the time slot t; and γ is the weight of energy consumption;
step 2.2: updating, by the external environment information acquisition module, the intelligent agent according to the following state space S;
$$S = [ {h}_{1}^{t} , {h}_{2}^{t} , ... , {h}_{n}^{t} ]$$
wherein,
$${h}_{n}^{t}$$
is a channel gain of the user n in the time slot t;
step 2.3: obtaining, by the intelligent agent, corresponding information according to the state space and calculating, by a plurality of neural networks, the information simultaneously, and integrating results of the plurality of neural networks and outputting a current action a to the external environment information acquisition module;
step 2.4: generating, by the external environment information acquisition module, a series of information while making decisions continuously and storing the information in a form of combination T=[s′, a, r, s], inputting the combinations into the experience pool first, and extracting each combination from the experience pool when training the multivariate neural network; wherein, the network is trained at intervals according to the information during network training and an intelligent agent network is updated; wherein:
s′ is state space information of a previous moment; a is a current selecting action; and r is a reward value of a previous selecting action; and
step 2.5: updating, by the external environment information acquisition module, a system target of the coordination system through the following formula, that is:
$$\begin{matrix}max \\ X , Y , τ\end{matrix} {\sum }_{t = 1}^{T} reward ( t )$$
$$s . t . {x}_{n , m}^{t} ∈ \{ 0 , 1 \} , m ∈ \{ 2 , ... , M - 1 \} , ∀ t , n ,$$
$${x}_{n , 1}^{t} = 0 , {x}_{n , M}^{t} = 0 , ∀ t , n ,$$
$${y}_{j}^{t} ∈ [ 0 , 1 ] , ∀ t , j ,$$
$${τ}_{n}^{t} ∈ [ 0.1 , 1 ] , ∀ t , n .$$

3. The cooperation method based on the edge computation and the directed acyclic graph adopting the multi-user platform according to claim 2, wherein the cooperation gain G(t) of the time slot t is constructed through the following formula:
$$G ( t ) = log 10 ( {y}_{j}^{t} * {O}_{m 1 , m 2} ) ;$$
wherein, each multi-user cooperation decision of the time slot t in the system is
$${y}_{j}^{t} ,$$
j∈{1,2, . . . , J}, and when
$${y}_{j}^{t} = 1 ,$$
a transmission data volume is O_{m1,m2}.

4. The cooperation method based on the edge computation and the directed acyclic graph adopting the multi-user platform according to claim 2, wherein the energy consumption eₙ(t) of the user n in the time slot t is constructed through the following formula:
$${e}_{n} ( t ) = {μ}_{n} ( {τ}_{n}^{t} {f}_{n} ) {C}_{n , i} + {P}_{n} * {T}_{n , i}^{s , t}$$
wherein, energy consumption of local computation is controlled by the local computation frequency decision
$${τ}_{n}^{t} ∈ [ 0.1 , 1 ] ;$$
a computation method of the energy consumption of local computation is that energy consumption of task computation is equal to a product of a number of revolutions of cpu required by the task and energy consumption of each revolution of cpu; and the energy consumption of each revolution of cpu is
$${μ ( {τ}_{n}^{t} {f}_{n}^{l} )}^{2} ,$$
time consumption of transmission from the local to the edge is
$${T}_{n , i}^{s , t} ,$$
and a transmission frequency is Pₙ
